(19) United States
(12) Patent Application Publication
(10) Pub. No.: US 2010/0031516 A1
(43) Pub. Date: Feb. 11, 2010

(54) Sewing rule steady

(76) Inventors: Charles Anthony Atkins, Victoria (AU); Marita Therese Jones, Victoria (AU)

Correspondence Address: Marita Jones, P.O.Box 8513, Carrum Downs, 3201, AU

(21) Appl. No.: 11/658,547

(22) PCT Filed: Sep. 19, 2005
(86) PCT No.: PCT/AU2005/001430

§ 371 Date: Jan. 23, 2007

(30) Foreign Application Priority Data
Dec. 7, 2004 (AU) 2004906994

(51) Int. Cl. B43L 12/00; B26B 29/06

(52) U.S. Cl. 30/289

(57) ABSTRACT

The device (9) has a pair of rounded triangular ends 8 mm thick (10) joined by a wooden handle (12). One side of each end is cut out to 3 mm, depth (13). This is the side of the end which rests on top of the ruler. The other side of each end is flat (14). The ends are connected by two strips (15, 16) 6 mm thick. Perpendicular to these strips are (2) reinforcing strips (17, 18) 6 mm thick. The strip (16) is affixed to the bottom of the flat side of each end to form a step (16). This is the strip which rests on the outside of the ruler. The strip (15) affixed to the bottom of the cut out side of each end. This is the strip which rests on top of the ruler. The underside of both strips have rubber feet affixed to them at 5-10 cm intervals. The handle (12) is 4.5 cm above the ruler (8) in order to enable visibility of the position of the fabric edge (7) and the ruler (8). The transparent quality of the device is a vital quality to the user. In use moderate downward pressure on the handle transmits pressure onto the mat (6) and locks the ruler in place. The selected ruler width line (4) is aligned with the fabric edge (5) and the rotary cutter is run along the rulers edge. The advantage of this device is that it allows visibility of all necessary equipment whilst preventing the ruler from slipping thereby wasting fabric. It keeps the hands away from the potential danger of the rotary cutter.

### FIELD OF THE INVENTION

This Invention concerns devices for facilitating the cutting of fabric.

### BACKGROUND OF THE INVENTION

In patchwork quilting and related handcrafts, strips and squares are cut from the fabric on a cutting mat with a rotary cutter or other cutting implement. As the strips need to have mutually parallel edges, a patchwork/quilting ruler is used. Rulers are made of transparent plastic with a very smooth surface. A series of width markings are marked on the surface. The quilter moves the ruler over the fabric, aligns a selected line with the existing cut edge of the fabric and presses the ruler against the fabric where the cut is made against the edge of the ruler.

In practice, one hand is not sufficient to immobilise the ruler while the cutter travels from one selvedge to the other, requiring the user to continuously move the hand on the ruler in a ‘crabwalk’ motion. The ruler is prone to slide during the cut and fabric is wasted. The rotary cutter is a very sharp instrument, and is also prone to slip across the ruler during the cut. The risk of cutting parts of the hand with the rotary cutter is very high.

### SUMMARY OF THE INVENTION

The apparatus aspect of the invention provides a rule steady comprising a handle capable of applying immobilising force to parallel sites on the longitudinal axis of the ruler and sites clear of the ruler.

The sites may each have contact feet with an effective non-slip surface. In this way the steady resists the ruler sliding which occurs when the cutter presses against the ruler. The site of the steady which rests on the ruler is 3 mm higher than the site which rests clear of the ruler, to enable the steady to be completely flat when in use, ensuring maximum downward force without any tilting effect.

The handle delivers force to sites along the length of both sides. The ends may be separated by 250-400 mm. Parallel with the handle are 2 clear Acrylic strips 24 mm wide, with rubber feet placed at intervals of 5-10 cm. At 90° to these strips, placed on the inner edge closest to the handle are 2 further Acrylic strips 25-30 mm high to add rigidity to the device. Operation is assisted by having the handle parallel to the long edge of the ruler. The handle is made of wood or plastic. The feet are made of rubber or rubber compound and attached securely to the acrylic strips.

### DRAWINGS

FIG. 1 is a side view of the invention

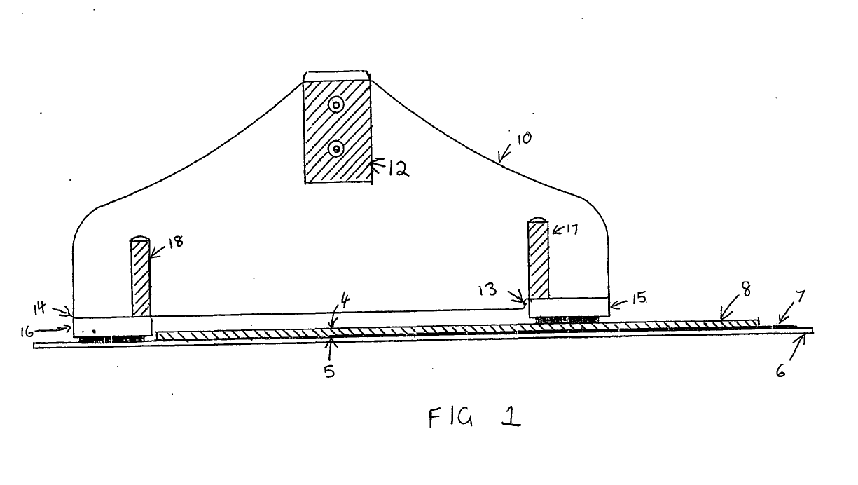

FIG. 2 is a detailed plan of the invention

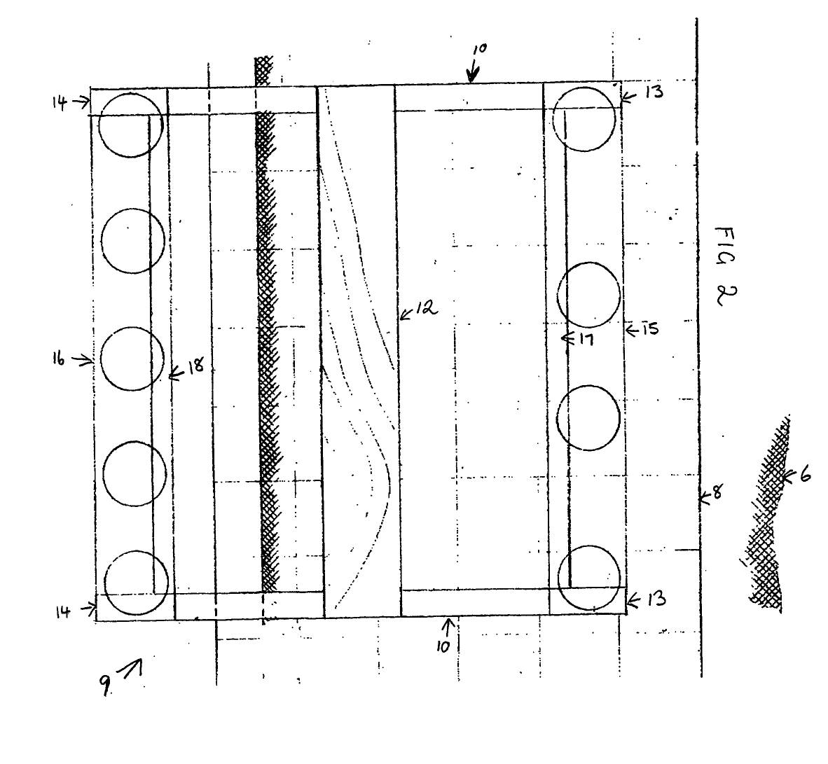

### DETAILED DESCRIPTION OF DRAWINGS

In reference to the drawings, the sewing ruler is made of Acrylic and lies across the fabric. The ruler is marked to enable the user to cut particular widths of fabric from one edge to the other. The edge of the ruler guides the rotary cutter (not shown). A cutting mat is usually used to protect the work surface.

The device 9 has a pair of rounded triangular ends 8 mm thick 10 joined by a wooden handle 12. One side of each end is cut out to 3 mm depth 13. This is the side of the end which rests on top of the ruler. The other side of each end is flat 14. The ends are connected by two strips 15, 16 6 mm thick. Perpendicular to these strips are 2 reinforcing strips 17, 18 6 mm thick. The strip 16 is affixed to the bottom of the flat side of each end to form a step 16. This is the strip which rests on the outside of the ruler. The strip 15 is affixed to the bottom of the cut out side of each end. This is the strip which rests on top of the ruler. The underside of both strips have rubber feet affixed to them at 5-10 cm intervals.

The handle 12 is 4.5 cm above the ruler 8 in order to enable visibility of the position of the fabric edge 7 and the ruler 8. The transparent quality of the device is a vital quality to the user.

In use moderate downward pressure on the handle transmits pressure on to the mat 6 and locks the ruler in place. The selected ruler width line 4 is aligned with the fabric edge 5 and the rotary cutter is run along the rulers edge.

1. The device has a pair of rounded triangular ends 8 mm thick joined by a wooden handle. One side of each end is cut out to 3 mm depth. Between the ends are acrylic strips ranging in length from 250-400 mm, which have rubber feet affixed to the underside at 5-10 cm intervals. Each of these strips have an acrylic strip placed at 90° on the inside edge to add rigidity.

2. The device is used to ensure that no slipping of the ruler takes place when making a cut using a rotary cutter or other cutting implement.
